(19) United States
(12) Patent Application Publication
(10) Pub. No.: US 2024/0263322 A1
(43) Pub. Date: Aug. 8, 2024

(54) METHODS, DEVICES, AND SYSTEMS FOR CONTROLLING COMPRESSION OF AN ELECTROCHEMICAL CELL STACK

(71) Applicant: ELECTRIC HYDROGEN CO., Natick, MA (US)

(72) Inventors: Michael BUCHMAN, Pacifica, CA (US); Raffi GARABEDIAN, Los Altos, CA (US); Jeffrey Dean GLANDT, Vancouver (CA)

(21) Appl. No.: 18/685,428

(22) PCT Filed: May 5, 2023
(86) PCT No.: PCT/US23/21230

§ 371 Date: Feb. 21, 2024

Related U.S. Application Data
(60) Provisional application No. 63/338,951, filed on May 6, 2022.

(51) Int. Cl. C25B 9/77; C25B 9/23; C25B 15/023

(52) U.S. Cl. CPC C25B 9/77; C25B 9/23; C25B 15/023

(57) ABSTRACT

The following disclosure relates to a system and method of actively managing electrolyzer stack compression. The method includes receiving: by a data acquisition unit, stack data from an electrolyzer stack in real time; providing, by the data acquisition unit, the stack data to a compression force controller; and controlling, by the compression force controller, how much force is applied by a force generating mechanism to the electrolyzer stack based on the stack data.

The present patent document claims the benefit of U.S. Provisional Patent Application No. 63/338,951, filed May 6, 2022, which is hereby incorporated by reference in its entirety.

### FIELD

The following disclosure relates to electrochemical devices, systems, and components thereof. More specifically, the following disclosure relates to actively managing (e.g., in real-time or periodically) the compression of a stacked fluidic device such as an electrochemical cell stack or fuel cell stack.

### BACKGROUND

A fuel cell is an electrochemical device in which the energy of a chemical reaction is converted directly into electricity. Unlike an electric cell or battery, a fuel cell does not run down or require recharging. Instead, the fuel cell operates as long as the fuel and an oxidizer are supplied continuously from outside the cell.

A fuel cell includes an anode to which fuel, (e.g., hydrogen or methanol), is supplied. The fuel cell further includes a cathode to which an oxidant, (e.g., air or oxygen), is supplied. The two electrodes of a fuel cell are separated by an ionic conductor electrolyte. In the case of a hydrogen-oxygen fuel cell with an alkali metal hydroxide electrolyte, the anode reaction is: 2H₂+4OH⁻→4H₂O+4e⁻ and the cathode reaction is O₂+2H₂O+4e⁻→4OH⁻. The electrons generated at the anode move through an external circuit containing the load and pass to the cathode. The OH⁻ ions generated at the cathode are conducted by the electrolyte to the anode, where they form water by combining with hydrogen. The water produced at the anode is removed continuously in order to avoid flooding the cell. Hydrogen-oxygen fuel cells using ion exchange membranes or immobilized phosphoric acid electrolytes found early use in the Gemini and Apollo space programs, respectively.

Hydrogen fuel cells are classified according to operating temperature and electrolyte type. Five different categories of hydrogen fuel cells according to the type of electrolyte used include: phosphoric acid, molten carbonate, solid oxide, proton-exchange membrane, and alkaline.

An electrolysis cell performs a similar operation, but in a reverse direction from a fuel cell. Electrolysis uses electrical energy to drive a chemical reaction. For example, water is split to form hydrogen and oxygen. While in principle an electrolysis cell is a fuel-cell “operating in reverse,” the detailed operational requirements are such that the two cells have quite different designs and material limitations.

Electrolyzer systems use electrical energy to drive a chemical reaction. For example, water is split to form hydrogen and oxygen. The products may be used as chemical feedstocks and/or energy sources. In recent years, improvements in operational efficiency have made electrolyzer systems competitive market solutions for energy storage, generation, and/or transport. For example, the cost of generation may be below $10 per kilogram of hydrogen in some cases. Decreases in cost, increases in efficiency, and/or improvements in operation will continue to drive installation of electrolyzer systems.

### SUMMARY

In one embodiment, a system includes an electrolyzer stack having a plurality of electrolytic cells, a force generating mechanism operable to apply a force to compress the electrolyzer stack, a compression force controller in communication with the force generating mechanism, and a data acquisition unit in communication with the electrolyzer stack and the compression force controller. The compression force controller is operable to control how much force is applied by the force generating mechanism. The data acquisition unit is operable to measure, monitor, and/or receive system data from the plant or electrolyzer stack in real time. The compression force controller is configured to control how much force is applied by the force generating mechanism based on the system data measured, monitored, and/or received by the data acquisition unit.

In another embodiment, a method of actively managing electrolyzer stack compression is disclosed. The method includes receiving, by a data acquisition unit, system data in real time from a system having an electrolyzer stack; providing, by the data acquisition unit, the system data to a compression force controller; and controlling, by the compression force controller, how much force is applied by a force generating mechanism to the electrolyzer stack based on the system data.

In another embodiment, a system includes an electrolyzer stack having a plurality of electrolytic cells, and a support structure coupled to the electrolyzer stack. The support structure uniformly applies variable force to compress the electrolyzer stack.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical cell.

FIG. 2 depicts an example of various layers within an electrochemical cell.

FIG. 3 depicts an example of a section of a system having an electrochemical stack.

FIG. 4 depicts a sectional view of an example of a system for actively controlling stack compression.

FIG. 5 depicts a sectional view of an example of a system for actively controlling stack compression.

FIG. 6 depicts a perspective view of an example of a system for actively controlling stack compression.

FIG. 7 depicts a sectional view of an additional example of a system for actively controlling stack compression.

FIG. 8 depicts a sectional view of an additional example of a system for actively controlling stack compression.

FIG. 9 depicts an example method for actively controlling stack compression.

FIG. 10 depicts an example communication system between an electrolytic stack and a computing device having a controller over a connected network.

FIG. 11 depicts an example of a computing device having a controller.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

Electrochemical cell stacks or systems may refer to fuel cells, electrolysis cells, or any other stacked fluidic cell device or system. While the following description primarily relates to electrolysis cell stacks and systems, the improved mechanisms, devices, systems, and methods disclosed herein may also be applicable to other stacked fluidic cell devices and systems (such as fuel cells). In other words, the improvements disclosed herein, while discussed with relation to an electrolysis cell stack or system may also be applicable to a fuel cell stack or system and should not be construed as limited to one or the other.

An electrolyzer or electrolysis system may include one or more electrolyzer stacks, wherein each stack is made up of a plurality of individual electrolytic cells. The discussed architectures and techniques may support the management of the compression of electrolyzer stacks. Each stack may be independently connected to power electronics, water, and gas systems. In some cases, a subgroup of electrolyzer stacks may be coupled together through one or more mechanisms. In some cases, each stack and/or sub-group may be compressed independently using a separate support structure. In other cases, each stack and/or sub-group may be compressed in unison using the same support structure.

In some cases, the compression of an electrolyzer stack is actively managed during the operation and life cycle of an electrolyzer system in order to maintain optimal membrane electrode assembly (MEA), electrical contact resistance, and/or seal compression. In some cases, the compression of an electrolyzer stack is varied during the operation and the lifetime of the (or each) stack to maintain MEA compression, minimize electrical contact resistance, and/or extend seal life. In addition, because stacks may operate through a range of temperatures and incorporate thermally mismatched materials, provisions are needed for substantial thermal expansion mismatch between a structure providing compression and the electrolyzer stack.

Furthermore, electrolyzer stacks may require precision machined flat end plates that are extremely stiff in order to provide uniform compression of the stack components (e.g., flow plates, conducting transfer layers, seals, membrane). The tolerances in such systems are extremely tight, and the resulting end plates (which are also usually fluid manifolds) are extremely thick, heavy, and costly. The problem is exasperated as the size (area) of the electrolyzer stack increases.

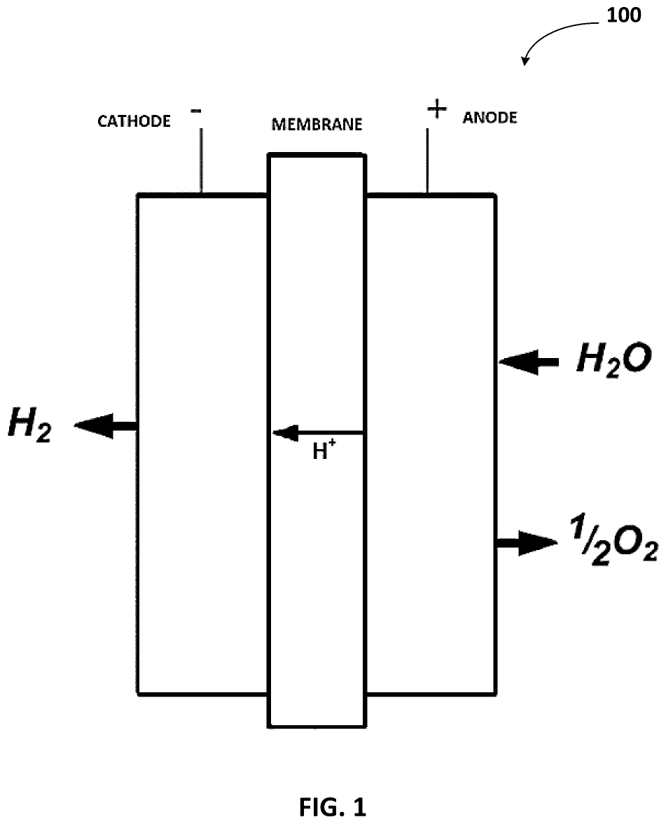

FIG. 1 depicts an example of an electrolytic cell for the production of hydrogen gas and oxygen gas through the splitting of water. The electrolytic cell includes a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed significant importance and renewed attention as a potential foundation for a decarbonized “hydrogen economy.” Other types of electrolyzers may be used as well.

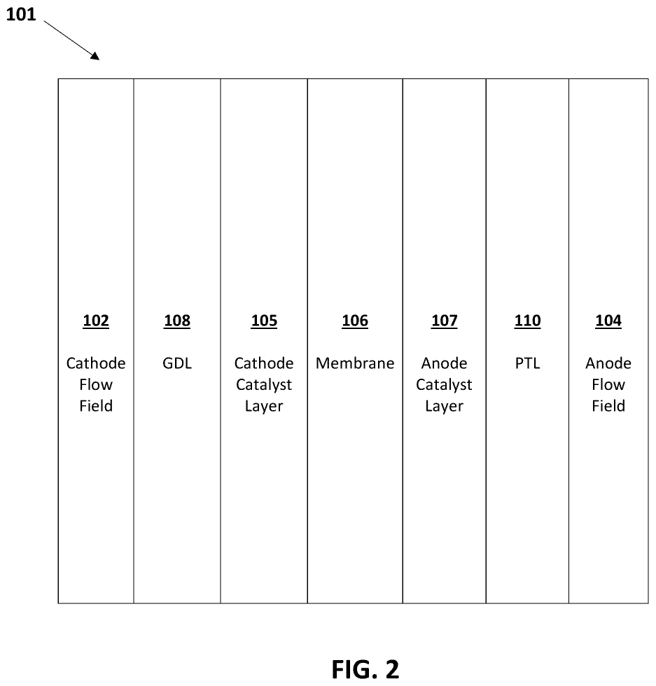

Because the performance of a single electrolytic cell may not be adequate for many use cases, multiple electrolytic cells may be placed together to form a “stack” of electrolytic cells, which may be referred to as an electrolyzer stack, electrolytic stack, or electrochemical stack. In one example, an electrochemical stack may contain 50-1000 cells, 50-100 cells, 500-700 cells, or more than 1000 cells. Any number of cells may make up an electrochemical stack. FIG. 2 depicts an additional example of an electrochemical or electrolytic cell.

Specifically, FIG. 2 depicts a portion of an electrochemical cell 101 having a cathode flow field 102, an anode flow field 104, and a membrane 106 positioned between the cathode flow field 102 and the anode flow field 104. In certain examples, the membrane 106 may have an overall thickness that is less than 1000 microns, 500 microns, 100 microns, 50 microns, 10 microns, etc.

In certain examples, additional layers may be present within the electrochemical cell 101. For example, one or more additional layers 108 may be positioned between the cathode flow field 102 and membrane 106. In certain examples, this may include a gas diffusion layer (GDL) 108 may be positioned between the cathode flow field 102 and membrane 106. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

Similarly, one or more additional layers 110 may be present in the electrochemical cell between the membrane 106 and the anode flow field 104. In certain examples, this may include a porous transport layer (PTL) positioned between the membrane 106 (e.g., the anode catalyst layer 107 of the catalyst coated membrane 106) and the anode flow field 104.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

In some examples, an anode catalyst coating layer may be positioned between the anode flow field 104 and the PTL.

The cathode flow field 102 and anode flow field 104 of the cell may individually include a flow field plate composed of metal, carbon, or a composite material having a set of channels machined, stamped, or etched into the plate to allow fluids to flow inward toward the membrane or out of the cell.

Since the performance of a single electrolytic cell may not be adequate for many use cases, multiple cells may be placed together to form a “stack” of cells, which may be referred to as an electrolyzer stack, electrolytic stack, electrochemical stack, or simply just a stack. In one example, a stack may contain 50-1000 cells, 50-100 cells, 500-700 cells, or more than 1000 cells. Any number of cells may make up a stack.

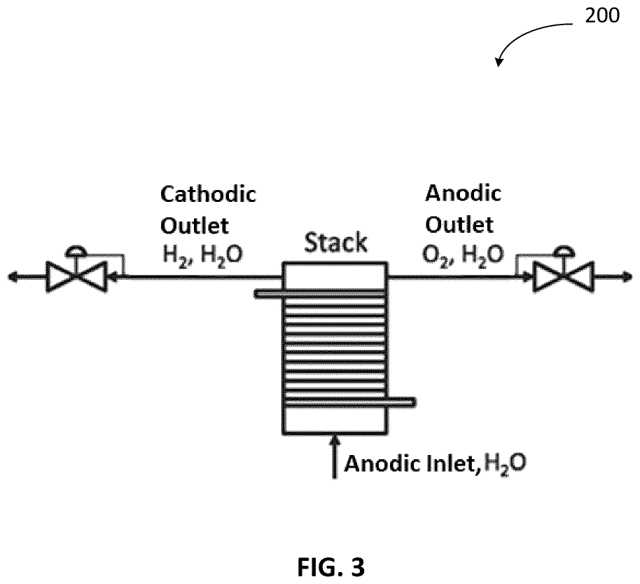

FIG. 3 depicts an example of a portion of electrolysis system for producing hydrogen gas and oxygen gas from water. The system includes a stack including a plurality of electrochemical or electrolytic cells, such as the cell of FIG. 1 or FIG. 2. The stack is configured to receive water through an anodic inlet. The system further includes a cathodic outlet at an outlet of the stack. The cathodic outlet transfers the hydrogen gas produced from the electrolytic cells to further downstream components for further processing. In certain configurations, a water byproduct is also produced at the cathodic outlet (wherein the water may be used as a coolant for the hydrogen gas produced). Additional downstream components following the cathodic outlet are not depicted, but may include water-gas separators, purifiers, heat exchangers, circulation pumps, pressure regulators, etc. In FIG. 3, a cathodic pressure regulator is depicted at the cathodic outlet. This pressure regulator may be positioned further downstream from the cathodic outlet after one or more further components such as a water-gas separator or purifier but is depicted at the particular location in FIG. 3 for simplicity.

Further, the electrolysis system includes an anodic outlet that transfers the oxygen gas produced from the electrochemical cells within the stack as well as unreacted water byproduct to further downstream components for further processing. Again, the additional downstream components following the anodic outlet are not depicted, but may include water-gas separators, purifiers, heat exchangers, circulation pumps, pressure regulators, etc. In FIG. 3, an anodic pressure regulator is depicted at the anodic outlet. This pressure regulator may be positioned further downstream from the anodic outlet after one or more further components such as a water-gas separator or purifier but is depicted at the particular location in FIG. 3 for simplicity.

In another embodiment, an arrangement is provided with multiple cell stacks in series/parallel.

In some cases, each cell in a stack may need to accommodate two or three different streams of water flowing past the cell (e.g., water flowing on the anode side, on the cathode side, and in some cases, within a coolant stream) as well as allowing electricity to be conducted through the cell. Electrolyzer systems operate under pressure (e.g., the water flows across the cells in the stack at high pressures), which means the water needs to be sealed within the stack. In one example, an electrolyzer stack may operate at 10 atm or higher. Seals surrounding the cells may need to have force applied to the sealing areas to work effectively (i.e., in order to form an appropriate seal). Further, because water pressure is applied to the cells throughout the stack, there is a tendency for the entire stack to want to separate under this pressure. Thus, in order to pre-compress the seals and to hold the entire stack together during operation, the stack and individual cells need to be compressed.

In some cases, a stack may be under variable pressure. In one example, when the stack is turned off, the pressure inside the stack may decrease, which means the stack may be subjected to various pressure cycles. By reducing seal compression when the electrolyzer stack is not operating, this reduces the number of overall compression sets and the seal lifetime is extended. Also, for the seal, upon pressurization, the seal compression can be reduced, and it will also seal less pressure.

Further, in some cases, the stack may need to accommodate for thermal expansion due to thermally mismatched material. When the cell stack is introduced to different temperatures, (e.g., ambient air temperatures or different operating conditions), the materials within the cell stack may expand or compress, causing a change in pressure. This will change both the MEA and seal compression, as a result the stack may not operate efficiently or become damaged.

Uncontrolled compression of electrolyzer stacks and cells leads to a number of problems, including under and over-compression of the MEA, a reduction of seal lifetime, and under and over-compression of the stack due to thermally mismatched materials.

For the cells in a stack, there may be an ideal membrane contact stress. When an MEA is under compressed, the contact resistance is high, and the performance is low. When the MEA is over-compressed, then the MEA can be damaged, and its lifetime can be shortened. Also, MEA over-compression may suppress mass transport (i.e., water to electrode, gas away from electrode). Thus, maintaining an optimal MEA compression, including the ideal membrane contact stress, during operation and throughout the lifetime of the cells and stack may be desirable.

The seal, when compressed, degrades over time and over the many compression sets. Seals may also creep after many compression sets, meaning the seals lose their original shape and become compacted or flattened. Both seal degradation and creep lead to less sealing force (i.e., the seal being able to seal less pressure) and/or leaks. Thus, managing the compression of a stack for optimal and consistent MEA and seal compression may be desirable.

Existing solutions are static electrolyzer compression systems, which compress the stack once during manufacturing and then do not adjust the compression based on operating conditions or through the lifetime of the stack. This means that during operation and over the lifetime of the stack, the compression of the MEA moves away from optimal and the performance and/or lifetime of the stack is reduced. Additionally, when the seal stays compressed at all times, its lifetime is lower, or during pressurization, it is compressed less and may seal less pressure (i.e., less sealing force).

In certain commercial embodiments, compression is done using static/passive large bolt systems. These bolt systems may include long rods, bolts, or tie rods with numerous washers, such as conical spring washers (e.g., Belleville washers), stacked on one another to form a spring-like structure and attached to the rods or bolts. These bolts may be torqued to a known setting to apply a known clamp load, or flexible pre-load.

The use of Belleville washers may create a bulky solution for stack compression that may limit pressure fluctuations on the stack but does not completely eliminate the pressure fluctuations. Further, as an electrolyzer stack ages, adjusting the compression in real time without direct human intervention is impossible with a passive system. Thus, a system that may uniformly compress the stack components in real time, or at least periodically, during the lifetime of the stack's operation, while using inexpensive, roughly machined end plates, is desirable.

Static compression systems, including the large bolt system described above, problematically do not allow for a change in compression load applied to the stack to accommodate for things like thermal expansion, increased stack pressure, and seal and/or material degradation. For these reasons, static compression systems also do not allow for changing compression loads in response thermal expansion and do not allow to adjust the compression in real time. Nor do static compression systems work well with variable pressure systems, because the compression load remains the same whether that initial pre-set compression load is needed or not.

Therefore, as disclosed herein, an optimal or improved solution may include using a dynamic compression system that allows the compression force applied to the stack to be changed or adjusted during operation of the stack and over the lifetime of the stack. Such a dynamic compression system may advantageously include an actively controlled force generating mechanism that allows for maintaining optimal or ideal compression or stress at all times under any condition.

In certain examples, the dynamic or active compression may be performed mechanically (e.g., using motor and gears) or with hydraulics or with compressed air/liquid bladders. For example, the active compression system may include a hydraulic system, hydraulic nuts, roller screw mechanism/actuator, inclined planes and motors, and the like. Any and all types of electro-mechanical, electro-hydraulic, hydraulic, pneumatic, direct motor driven systems, rack and pinion system, and the like may be used. All types of actuators, such as hydraulic bladders, pneumatic bladders, and the like may be used. Any and all ways of creating force that is controllable may be used to actively manage stack compression.

Optimal compression points may be determined by predetermined design specifications or by measuring operating pressure, measuring temperature, optical measurements of stack dimensions, or measurement of other operating conditions.

The initial stack compression may be based on the force required for sealing and optimal MEA compression. Force required for sealing and optimal MEA compression are design specifications. The amount of force applied may change, however. For instance, upon pressurization of the electrolyzer stack, the hydraulic or mechanical mechanism may increase stack compression force based on a pressure measurement to counter the pressure force and maintain optimal MEA compression and seal force. As the electrolyzer stack heats up and hydrates, based on temperature measurements, the stack compression may be reduced to avoid MEA over compression due to the expansion of thermally mismatched material. Over the operating lifetime, as some materials may flatten due to the compression sets and the stack gets shorter, the dynamic or active compression system may monitor these dimension changes and increase stack compression to counter the material compression set and lower MEA compression. In one example, the active compression system may monitor stack height optically. In another example, various other sensors may be used. During depressurization and off periods, the active compression system may reduce stack compression to avoid MEA over compression and also to lower the seal compression to extend the seal life. Maintaining optimal MEA and seal compression maximizes performance and lifetime of the electrolyzer stack and components therein, such as the seals.

### Controlling Compression in an Electrolyzer Stack Through Periodic or Routine Adjustments

In one embodiment, compression of the electrolyzer stack may involve periodic or routine adjustments during the operating lifetime of the stack.

In such an embodiment, the electrolyzer stack may be temporarily coupled to a compression system to adjust or fine-tune the stack pressure. This coupling/adjustment may initially be performed when the cell stack is manufactured. Subsequently, after a period of time of operation of the cell stack, the stack may be re-coupled to the compression system for analysis and potential readjustment of the cell stack pressure. The recoupling may take place during operation of the stack, or during a maintenance interval where the stack has been shut down.

The period of time of operation (e.g., the interval of time between adjustments) may be variable or configurable (e.g., every week, every month, every year of operation of the cell stack). This advantageously provides a check-in opportunity to make fine or course adjustments to the operation conditions of the cell stack as it potentially drifts from its desired operating parameters over the course of operation.

In this example, the external attachable compression system may include a hydraulic compression system having one or more external hydraulic piston actuators. Fluid pressure may be applied to the stack components through the hydraulic compression system. This may include a pressurized bladder placed between an end plate and the stack components, though it may also be implemented as a sealed cavity. This approach provides for uniform compression pressures and completely decouples end plate stiffness and flatness from the tolerance stack up and thermal motion of the stack components relative to the compression structure.

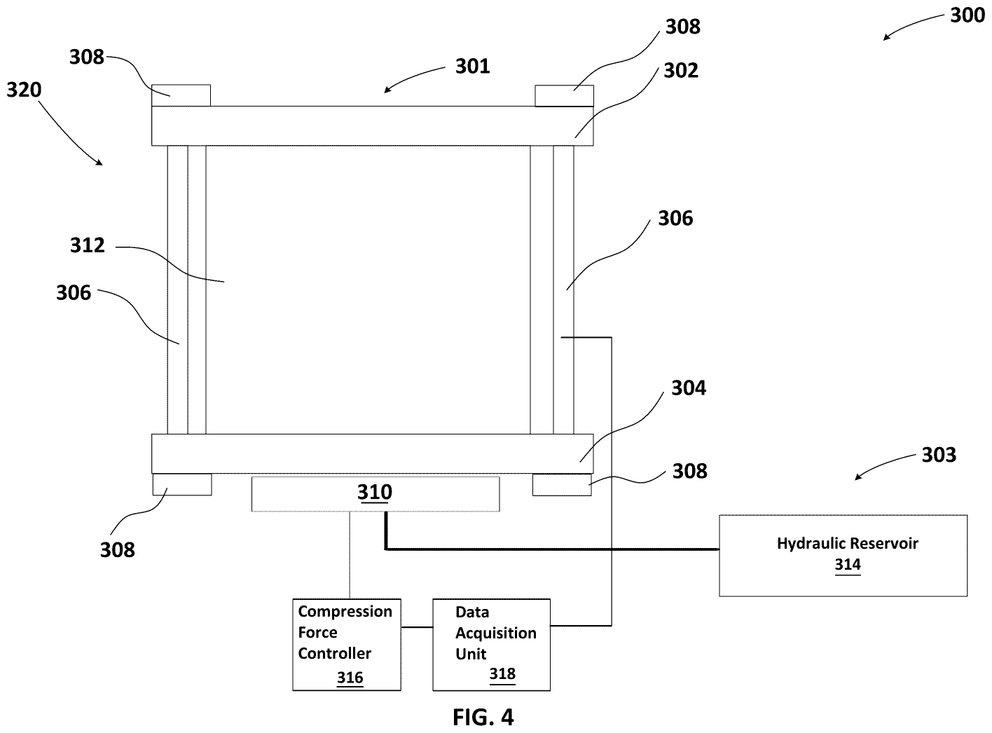

FIG. 4 depicts an example of a combined system 300 for routinely or periodically controlling stack compression. The combined system 300, as depicted in FIG. 4, may include two separate, attachable systems. The first system is an electrochemical system 301 that includes an electrochemical cell stack 312 and a support structure 320 of the stack 312. The stack 312 may be an electrolyzer stack and may include a plurality of individual cells. The number of cells within the cell stack 312 is configurable. In some examples, the number of cells may be within a range of 50-1000 cells, 50-100 cells, 500-700 cells, or more than 1000 cells.

The support structure 320 for the cell stack in the electrochemical system 301 may include two end plates 302 and 304, a plurality of tie rods or bolts 306, and a plurality of nuts or bolt heads 308 associated with the plurality of tie rods 306 (e.g., wherein the tie rods are threaded through the nuts). The two end plates may include of a first end plate 302 and a second end plate 304. The first end plate 302 is positioned near the top of the stack 312 and the second end plate 304 is positioned near the bottom of the stack 312. The two end plates are configured to be coupled to the plurality of tie rods 306, such that the stack 312 is positioned between the first end plate 302 and the second end plate 304. In certain embodiments, the plurality of tie rods 306 include at least one tie rod 306 near each corner of the system (e.g., for a total of at least four tie rods). In certain cases, additional tie rods may be positioned between each corner of the system.

In certain examples, while not depicted in FIG. 4, instead of threading the tie rods through the plurality of nuts or bolt heads on one end of the tie rod, the tie rods may be directly threaded into a taped feature in the first end plate 302.

In another examples, the tie rods may have a bolt head configuration with one secured or fixed end and one open threaded end to receive a nut. In such an alternative embodiment, elements 308 depicted on the top end of the tie rod in FIG. 4 would refer to fixed, unremovable ends of a bolt head. In other words, alternative forms of fixing or securing one end of a tie rod may be provided instead of a nut or bolt head configuration as depicted in FIG. 4.

The support structure 320 is configured to support and compress the stack 312 while under tension through an application of an external force to one of the ends of a tie rod (e.g., via a force generating mechanism described in greater detail below). Likewise, the support structure 320 may expand when the external force is removed or reduced, in which case the two end plates decompress. In some cases, the end plates of the support structure 320 conform to the entire stack 312 which allows the external force to be applied evenly. In other words, the support structure 320 is configured to apply the external force uniformly across the entire surface of the stack 312 on which the force is applied to (e.g., through an application of force to each tie rod of the plurality of tie rods). Further, the number of tie rods and the arrangement of the tie rods may be proportional to the size of the stack to provide uniform compression. Other configurations are possible.

The second system of the combined system 300 depicted in FIG. 4 refers to the compression system 303. In this example, the compression system 303 is configured to be detachably connected to the electrochemical system 301 to advantageously provide updates or adjustments to the pressure on the cell stack 312 of the electrochemical system 301. As noted above, the compression system may be attached to the cell stack 312 to provide an initial adjustment or compression on the cell stack 312 at the initial time of manufacturing of the cell stack 312. Additionally, periodic adjustments may be made during the operational life of the cell stack 312, wherein the compression system 303 may be reattached to the electrochemical system 301 to provide an operational monitoring and pressure adjustment on the cell stack 312.

As depicted in FIG. 4, the compression system 303 may include a force generating mechanism 310, a hydraulic reservoir 314, a compression force controller 316, a data acquisition unit 318.

The force generating mechanism 310 configured to apply an external force to the stack may include a hydraulic press or one or more hydraulic pistons. The force generating mechanism 310 may be configured to be attached or positioned on one end plate 302, 304 of the support structure 320 of the electrochemical system 301. In the depicted example, the force generating mechanism is positioned on the second plate 304 of the support structure. Force is configured to be generated by the force generating mechanism on the second plate 304 to compress the cell structure positioned in between the two end plates 302, 304 of the support structure. In this particular example, the force is a hydraulic compression force being supplied from a hydraulic reservoir attached to the force generating mechanism.

It may be advantageous to keep the force generating mechanism 310 only at or near the bottom of the stack for safety purposes (e.g., failures or leaks within the fluid lines coupled to the force generating mechanism 310 would not leak into the electrochemical stack 312).

As the stack 312 expands or compresses due to thermal expansion or material wear, the compression system 303 may be attached to the stack to adjust the compression of the stack to a predefined or optimal compression.

The compression system 303 may also include a compression force controller 316 in communication with the force generating mechanism 310, sensors (not illustrated), as illustrated in FIG. 4. The compression force controller 316 may be capable of setting and changing the force applied by the force generating mechanism 310 to the support structure 320. In this way, the force generating mechanism 310 is a controllable force generating mechanism. It may be also advantageous as the compression force controller 316 may adjust and accommodate for load balancing.

The compression system 303 may also include a data acquisition unit 318 in communication with the electrochemical system 301, cell stack 312, plant, and/or environmental sensors. The data acquisition unit 318 may be operable to measure, monitor, and receive data from the stack 312 in real time following the attachment of the compression system to the cell stack 312 and electrochemical system 301. The data acquisition unit 318 may include sensors (not illustrated) to measure, monitor, and receive system data. The system data may include plant data, environmental conditions, and/or stack data of an electrochemical stack such as pressure data, temperature data, seal data, cell and/or stack height data, gas concentration data, water data, and any other data indicative of the operating condition of the system having the electrochemical stack. In this regard, any number and types of sensors may be included in the data acquisition unit, such as pressure sensors, temperature sensors, seal sensors, gas concentration sensors, water sensors, and optical sensors.

The data acquisition unit 318 may be in communication with the compression force controller 316, such that the compression force controller 316 alters the force being applied by the force generating mechanism 310 based on the data received by the data acquisition unit 318. In this way, compression force applied to the stack 312 may be actively managed in real time based on operating conditions of the stack.

In certain examples, following the collection of data such as operational pressure data of the cell stack 312 using the data acquisition unit 318, the force generating mechanism 310 may be actuated to provide additional pressure to the support structure 320 and cell stack 312. Following the additional compression on the stack via the force generating mechanism 310, one or more nuts or bolt heads 308 of the support structure 320 may be adjusted or tightened to retain the adjusted compression on the cell stack.

Alternatively, through the monitoring of the cell stack pressure via the attached data acquisition unit 318 of the compression system 303, one or more of the nuts or bolt heads 308 of the support structure 320 may be loosened to relieve or decrease pressure on the cell stack 312 to return the pressure to a desired or optimal operational setting.

### Controlling Compression in an Electrolyzer Stack Using Hydraulic or Pneumatic Nuts

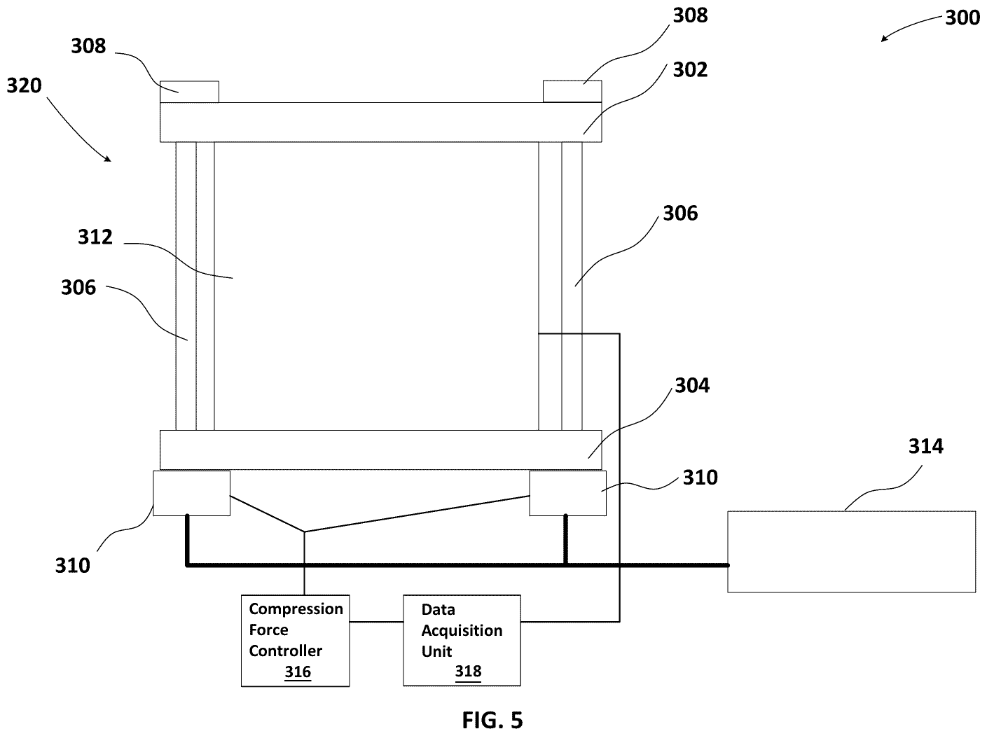

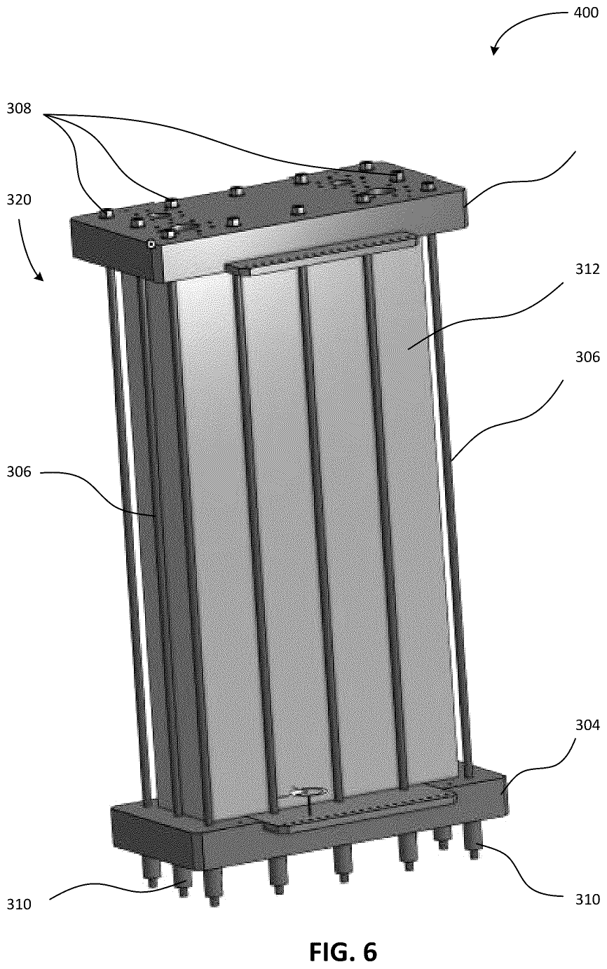

FIGS. 5 and 6 depict examples of systems for actively controlling stack compression. FIG. 5 depicts a two-dimensional sectional view, while FIG. 6 depicts a perspective view of a similar system.

The system 300 may include a stack 312, a force generating mechanism 310, a compression force controller 316, a data acquisition unit 318, and a support structure 320. The stack 312 may be an electrolyzer stack and may include a plurality of individual cells. While FIG. 5 shows a limited number of cells, the number of cells in the stack may be within a range of 50-1000 cells, 50-100 cells, 500-700 cells, or more than 1000 cells, for example. As noted above, any number of cells within a stack may be used. There may be various embodiments of a system for actively controlling stack compression.

Specifically, the support structure 320, illustrated in FIG. 5, includes of two end plates 302 and 304, a plurality of tie rods or bolts 306, and a plurality of nuts or bolt heads 308 associated with the plurality of tie rods 306 (e.g., wherein the tie rods are threaded through the nuts). The two end plates may include of a first end plate 302 and a second end plate 304. The first end plate 302 is positioned near the top of the stack 312 and the second end plate 304 is positioned near the bottom of the stack 312. The two end plates are configured to be coupled to the plurality of tie rods 306, such that the stack 312 is positioned between the first end plate 302 and the second end plate 304. In certain embodiments, the plurality of tie rods 306 include at least one tie rod 306 near each corner of the system (e.g., for a total of at least four tie rods). In certain cases, additional tie rods may be positioned between each corner of the system.

In an alternative embodiment, while not depicted in FIG. 5, instead of threading the tie rods through the plurality of nuts or bolt heads on one end of the tie rod, the tie rods may be directly threaded into a taped feature in the first end plate 302.

In another alternative embodiment, the tie rods may have a bolt head configuration with one secured or fixed end and one open threaded end to receive a nut. In such an alternative embodiment, elements 308 depicted on the top end of the tie rod in FIG. 5 would refer to fixed, unremovable ends of a bolt head. In other words, alternative forms of fixing or securing one end of a tie rod may be provided instead of a nut or bolt head configuration as depicted in FIG. 5.

The support structure 320 is configured to support and compress the stack 312 while under tension through an application of an external force to one of the ends of a tie rod (e.g., via a force generating mechanism described in greater detail below). Likewise, the support structure 320 may expand when the external force is removed or reduced, in which case the two end plates decompress. In some cases, the end plates of the support structure 320 conform to the entire stack 312 which allows the external force to be applied evenly. In other words, the support structure 320 is configured to apply the external force uniformly across the entire surface of the stack 312 on which the force is applied to (e.g., through an application of force to each tie rod of the plurality of tie rods). Further, the number of tie rods and the arrangement of the tie rods may be proportional to the size of the stack to provide uniform compression. Other configurations are possible.

In some cases, a force generating mechanism 310 configured to apply an external force to the stack may be one or more hydraulic nuts, pneumatic nuts, or bolt tensioners. For example, as depicted in FIG. 5, hydraulic nuts 310 may be coupled to at least one end of one or more of the tie rods 306 (e.g., every tie rod). In the example depicted in FIG. 5, hydraulic nuts 310 are positioned at the bottom of the stack 312, while additional (e.g., non-hydraulic) nuts 308 are fastened at the top of the tie rods 306 positioned at the top of the stack 312 and configured to provide a fixed or locking position to keep the first end plate 302 from moving. As noted above, in an alternative embodiment, hydraulic nuts 310 may be positioned at one end of the stack (e.g., the bottom of the stack) while the tie rods 306 are secured or fixed in place at the top end of the stack without the use of the nuts depicted in FIG. 5. In this alternative embodiment, the tie rods may be fixed or secured at the top end of the stack via a threading mechanism within the first end plate 302, wherein the tie rods are screwed or secured into the first end plate 302 directly without a need for an additional component (e.g., the nuts 308 depicted in FIG. 5). Alternatively, the tie rods may have a bolt head configuration with one secured or fixed end and one open threaded end to receive the hydraulic nut.

In an alternative embodiment, a force generating mechanism 310 may be positioned on each end of the tie rods (i.e., wherein the nuts 308 at the top of the tie rods may also be hydraulic or pneumatic nuts). In this example, the force created by the force generating mechanism is applied to opposing ends of the stack (e.g., to hydraulic nuts positioned on both ends of the stack).

It may be advantageous to keep the hydraulic nuts or the force generating mechanism 310 only at or near the bottom of the stack for safety purposes (e.g., failures or leaks within the fluid lines coupled to the hydraulic nuts would not leak into the electrochemical stack). The hydraulic nuts 310 positioned near the second end plate 304 may be actuated at a desired pressure to generate a desired force. As the stack 312 expands or compresses due to thermal expansion or material wear, the hydraulic nuts 310 may be actuated to keep a predefined or consistent compression on the stack 312.

In some cases, more than one hydraulic nut or a group of hydraulic nuts may be used. The number and size of hydraulic nuts may be determined based on the size and design of the support structure. For example, referring to FIG. 5, hydraulic nuts may be coupled to each of the tie rods to provide uniform compression to the stack. Various arrangements of the hydraulic nuts may be implemented to reach a desired uniform compression over the stack.

Further, a hydraulic reservoir or pneumatic source 314 may be coupled to the hydraulic nuts 310. Each of the hydraulic nuts 310 may have its own individual power source (e.g., hydraulic reservoir, pneumatic source, pressure source, or motor) or may have one power source powering all hydraulic nuts as a group.

In some cases, the hydraulic nuts may be run or connected either in series or in parallel. For instance, when in series, each hydraulic nut may be connected by one individual hose and may be connected through a T-junction to one power source. Sensors and valves may be placed in the hydraulic circuit to help provide power to the hydraulic nuts individually, detect failures, and/or help control the operation of the hydraulic nuts individually (i.e., load balancing). However, various arrangements and configurations may be implemented where the hydraulic nuts may be controlled or operated as a group.

In some cases, as mentioned above, the hydraulic nuts may be run in parallel. For example, multiple hoses and power sources may be used to control and operate each of the hydraulic nuts individually or in a group.

The system may also include a compression force controller 316 in communication with the force generating mechanism 310 (e.g., hydraulic nuts), sensors (not illustrated), and the support structure 320, as illustrated in FIG. 5. The compression force controller 316 may be capable of setting and changing the force applied by the force generating mechanism 310 to the support structure 320. In this way, the force generating mechanism 310 is a controllable force generating mechanism. It may be also advantageous as the compression controller may adjust and accommodate for load balancing.

In certain examples, the controller 316 may be configured to control all of the components (e.g., hydraulic nuts) of the force generating mechanism together such that a similar compression adjustment is applied to each hydraulic nut. Alternatively, the controller 316 may be configured to control each component (e.g., hydraulic nut) of the force generating mechanism independently of each additional component or hydraulic nut, such that a potentially unique compression adjustment is applied to each individual component or hydraulic nut of the force generating mechanism. In yet another embodiment, the hydraulic nuts or individual components of the force generating mechanism may be arranged or identified in specific zones or groups, and the controller 316 may be configured to control each zone or group independently from each additional zone/group to provide potentially unique compression adjustments to each zone/group. In some examples, the zones or groups may be defined based on the locations or impact areas for the components or hydraulic nuts of the force generating mechanism.

The system may also include a data acquisition unit 318 in communication with the stack 312, the plant, and/or environmental sensors. The data acquisition unit 318 may be operable to measure, monitor, and receive data from the stack 312 in real time. The data acquisition unit 318 may include sensors (not illustrated) to measure, monitor, and receive system data. The system data may include plant data, environmental conditions, and/or stack data of an electrochemical stack such as pressure data, temperature data, seal data, cell and/or stack height data, gas concentration data, water data, and any other data indicative of the operating condition of the system having the electrochemical stack. In this regard, any number and types of sensors may be included in the data acquisition unit, such as pressure sensors, temperature sensors, seal sensors, gas concentration sensors, water sensors, and optical sensors.

The data acquisition unit 318 may be in communication with the compression force controller 316, such that the compression force controller 316 alters the force being applied by the force generating mechanism 310 based on the data received by the data acquisition unit 318. In this way, compression force applied to the stack 312 may be actively managed in real time based on operating conditions of the stack.

In some cases, multiple stacks may be contained within a single support structure. In this example, the force applied by the force generating mechanism may be applied evenly across all stacks within the support structure. In another example, the support structure may be configured to allow the different stacks to receive different forces. In this example, there may be a single compression force controller and single data acquisition unit for all of the stacks within the single support structure. In another example, each stack within the support structure may be connected to a respective compression force controller and data acquisition unit.

### Controlling Compression in an Electrolyzer Stack Using Array of Springs

In an alternative embodiment for controlling compression in a stack, the support structure may include an array of springs positioned within the stack. The springs may be configured to function as a dampener to absorb changes in pressure (e.g., caused by changes in operating conditions or temperatures within the stack) through compression or expansion. The presence of the array of springs within the stack therein advantageously may avoid unnecessary forces acting on the end plates or outer components of the stack. Additionally, the array of springs does not require any additional controller or pressure monitoring system to adjust the compression on the stack. Instead, the compression control on the stack is indirectly controlled by the design configurations of the array of springs themselves, such as the material of the springs, length, or thickness of the springs, etc.

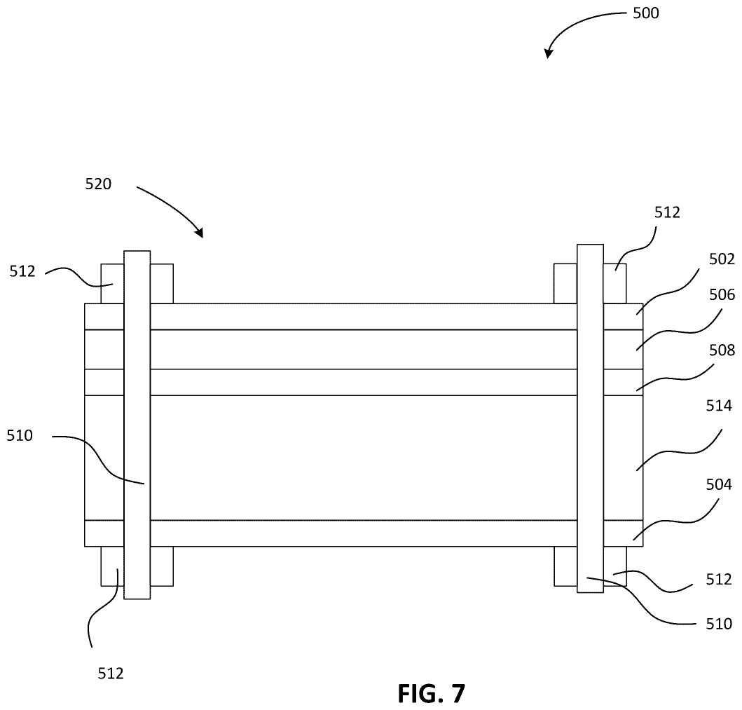

FIG. 7 depicts an example of such a system 500 having an array of springs. In this embodiment, the system 500 may uniformly compress the electrolyzer stack utilizing an array of springs and may be developed without the use of a controller. The system includes a stack 514 and a support structure 520. The stack 514 may be an electrolyzer stack and may include a plurality of individual cells. While FIG. 7 depicts a limited number of cells, the number of cells in the stack 514 may be within a range of 50-1000 cells, 50-100 cells, 500-700 cells, or more than 1000 cells, for example. As noted above, any number of cells within a stack may be used.

Referring to FIG. 7, the support structure 520 may include two end plates 502 and 504 and a plurality of tie rods 510. While only two tie rods are illustrated, additional tie rods (e.g., such as at each corner of the end plate) are possible. The two end plates may include a first end plate 502 and a second end plate 504. The first end plate 502 is positioned near the top of the stack 514, and the second end plate 504 is positioned near the bottom of the stack 514. The two end plates 502 and 504 are configured to be coupled to the plurality of tie rods 510, such that the stack 514 is positioned between the first end plate 502 and the second end plate 504.

The support structure 520 may further include nuts 512 at each end of the tie rod to hold together and compress the cell stack 514. Unlike the embodiment discussed above with FIGS. 5 and 6 having one or more hydraulic nuts positioned at the end of a tie rod, this embodiment depicted in FIG. 7 may not include such a component (i.e., each nut is not a hydraulic nut). In an alternative embodiment, one end of the tie rods 306 may be fixed or secured at the top end of the stack via a threading mechanism within the first end plate 302, wherein the tie rods are screwed or secured into the first end plate 302 directly without a need for an additional component. Alternatively, the tie rods may have a bolt head configuration with one secured or fixed end and one open threaded end to receive the nut.

The support structure 520 may further include an array of springs 506 and a spreader plate 508. The spreader plate 508 is positioned between the stack 514 and one of the end plates (e.g., the first end plate 502). While not depicted in FIG. 7, the spreader plate could alternatively be positioned between the stack and the second, lower end plate 504. The spreader plate 508 may be any material that is conductive and flexible.

The array of springs 506 are positioned between an end plate (e.g., the first end plate 502) and the spreader plate 508. As noted above, in an alternative embodiment, to the extent the spreader plate is positioned on the bottom of the stack near the second end plate, the array of springs could be positioned between the second end plate and the spreader plate.

The array of springs 506 may be configured to convey or transfer uniform compression across the spreader plate 508, which conforms to the stack components. The array of springs 506 may be configured to absorb a thermal mismatch with a commensurate change in pressure. For example, as the stack experiences different changes in temperature during different operating conditions of the stack, the stack will either expand or contract. The array of springs 506 may be configured to adjust or accommodate for the thermal mismatch and keeping the stack 514 under a desired compression. Various arrangements of the array of springs 506 may be implemented to reach a desired uniform compression over the spreader.

Such an improved solution having a system that allows for actively managing stack compression in real time based on an array of springs as described herein may provide various operating advantages over conventional operating cells/stacks. For example, a dynamic/active system allows smart decisions to be made about the amount of force to apply, and the displacement applied. Utilizing springs as dampers to help accommodate the change in pressure due to thermally mismatched materials may advantageously improve seal or cell membrane life. Further, the use of springs may advantageously allow the system to run without having to monitor the stack pressures when there is a change in temperature.

### Combination of Array of Springs and Hydraulic Nuts

In certain embodiments, the system may include both an array of springs and a force generating mechanism (e.g., hydraulic nuts or detachable hydraulic press or piston) combining the advantages of the embodiments discussed above with respect to FIGS. 4-7. The combination of both the array of springs and the hydraulic nut features may be advantageous in reducing the number of adjustments made using the hydraulic nuts. In other words, the array of springs may provide a first, coarse response to a change in pressure within the system to any fluctuations, and the hydraulic nut or force generating mechanism may provide a second, fine-tuned response to provide further stabilizing to a change within the system to maintain or control a steady-state operation. Additionally, the force generating mechanism may advantageously provide further compression control beyond the capabilities of the array of springs alone to provide further compression adjustments, particularly during start-up and shutdown of the stack.

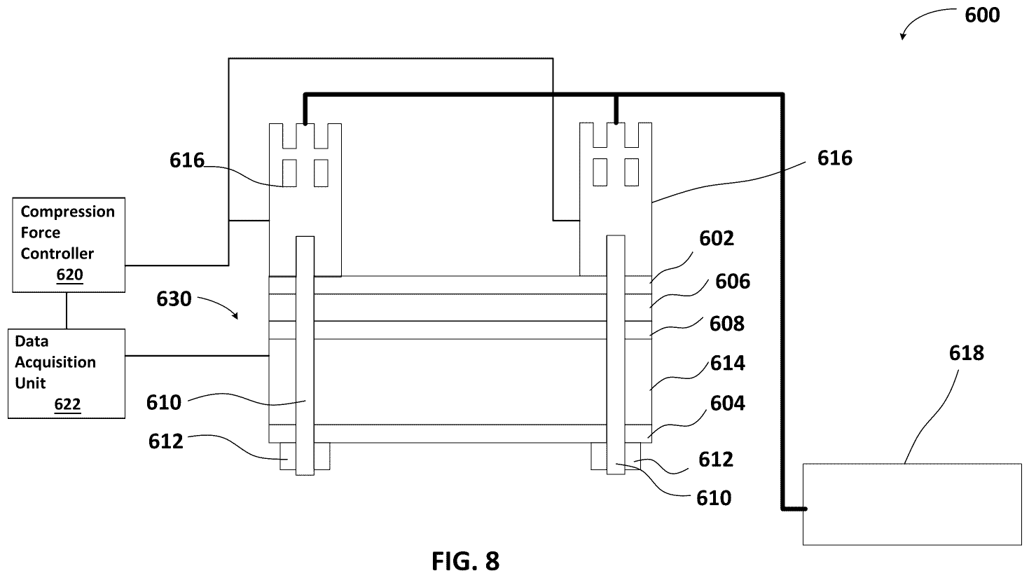

FIG. 8 depicts such an example that includes both the array of springs and force generating mechanism. Specifically, the system 600 includes a support structure 630 having two end plates 602 and 604, a plurality of tie rods 610, an array of springs 606, and a spreader plate 608. The two end plates may include a first end plate 602 and a second end plate 604. The first end plate 602 is positioned on the top of the stack 614, and the second end plate 604 is positioned on the bottom of the stack 614. The two end plates are configured to be coupled to the plurality of tie rods, such that the stack 614 is in between the first end plate 602 and the second end plate 604. Further, the spreader plate 608 is positioned between the stack 614 and the first end plate 602. The spreader plate 608 may be any material that is conductive and flexible.

Additionally, the array of springs 606 are positioned between the first end plate 602 and the spreader plate 608. As noted above, the array of springs 606 may be positioned to convey uniform compression to the spreader plate 608, which conforms to the stack components. The array of springs 606 may be configured to absorb the thermal mismatch with a commensurate change in pressure. For example, as the stack 614 experiences different changes in temperature, the stack 614 will either expand or contract. The array of springs 606 will accommodate for the thermal mismatch by keeping the stack 614 under a desired compression in conjuncture with a force generating mechanism 616. Various arrangements of the array of springs 606 may be implemented to reach a desired uniform compression over the spreader plate 608.

As depicted in FIG. 8, in addition to the array of springs, the system further includes a force generating mechanism 616. As stated above, the force generating mechanism 616 may be any type of mechanism capable of creating and adjusting an applied force. In some cases, the force generating mechanism 616 may be a hydraulic mechanism, a compressed air or fluid bladder mechanism, or an actuator mechanism. Other types of force generating mechanisms may be used. In certain examples, the force generating mechanism may be bolt tensioners.

In some cases, a force generating mechanism 616 configured to apply an external force to the stack may be one or more hydraulic nuts, pneumatic nuts, or bolt tensioners. For example, as depicted in FIG. 8, the force generating mechanism includes hydraulic nuts 616 that are coupled to at least one end of one or more of the tie rods 610 (e.g., every tie rod). In the example depicted in FIG. 8, hydraulic nuts 616 are positioned at one end of the stack, while additional (e.g., non-hydraulic) nuts 612 are fastened at the opposite end, configured to provide a fixed or locking position to keep plate 604 from moving. As noted above, in an alternative embodiment, hydraulic nuts 616 may be positioned at one end of the stack, while the tie rods 610 are secured or fixed in place at the opposite end of the stack without the use of the additional (e.g., non-hydraulic) nuts depicted in FIG. 8. In this alternative embodiment, the tie rods may be fixed or secured at the top end of the stack via a threading mechanism within the first end plate 604, wherein the tie rods are screwed or secured into the first end plate 604 directly without a need for an additional component (e.g., the nuts 612 depicted in FIG. 8). Alternatively, the tie rods may have a bolt head configuration with one secured or fixed end and one open threaded end to receive the hydraulic nut.

Further, a hydraulic reservoir or pneumatic source 618 may be coupled to the force generating mechanisms 616. Each of the force generating mechanisms 616 may have its own individual power source (e.g., hydraulic reservoir, pneumatic source, or motor) or may have one power source powering all hydraulic nuts as a group.

As mentioned above, the system may also include a compression force controller 620 in communication with the force generating mechanism 616, sensors (not illustrated), and the support structure 630, as illustrated in FIG. 8. The compression force controller 620 may be capable of setting and changing the force applied by the force generating mechanism 616 to the support structure 630. In this way, the force generating mechanism 616 is a controllable force generating mechanism. It may also be advantageous as the compression controller may adjust and accommodate for load balancing.

The system may also include a data acquisition unit 622 in communication with the stack 614. The data acquisition unit 622 may be operable to measure, monitor, and receive data from the stack 614 in real time. The data acquisition unit 622 may include sensors to measure, monitor, and receive system data of a system having an electrochemical stack. The system data may include plant data, environmental conditions, and/or stack data of an electrochemical stack such as pressure data, temperature data, seal data, cell and/or stack height data, gas concentration data, water data, and any other data indicative of the operating condition of the system having the electrochemical stack. In this regard, any number and types of sensors may be included in the data acquisition unit, such as pressure sensors, temperature sensors, seal sensors, gas concentration sensors, water sensors, and optical sensors.

The data acquisition unit 622 may be in communication with the compression force controller 620, such that the compression force controller 620 alters the force being applied by the force generating mechanism 616 based on the data received by the data acquisition unit 622. In this way, compression force applied to the stack may be actively managed in real time based on operating conditions of the stack.

As mentioned above, various configurations and embodiments may be desired as the support structures and force generating mechanisms may be interchanged.

### Methods for Actively Controlling Stack Compression

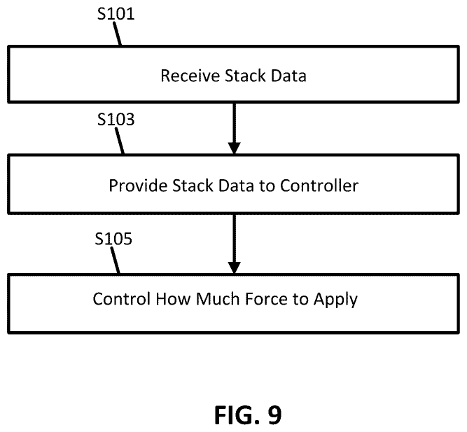

FIG. 9 depicts an example method for actively controlling stack compression (e.g., either in real time or via periodic adjustments). In act S1, system data (e.g., plant data, environmental conditions, and/or stack data) may be received from an electrolyzer stack. This system data may be obtained via a data acquisition unit configured to receive the system data. The data acquisition unit may be permanently attached to the stack or may be configured to be temporarily or removably attached to the stack at defined periodic intervals as described above. In certain examples, the system data may be received in real time. The system data may include plant data, environmental conditions, or stack data such as pressure data, temperature data, seal data, cell and/or stack height data, gas concentration data, water data, and any other data indicative of the operating condition of the plant or stack. In this regard, any number and types of sensors may be included in the data acquisition unit, such as pressure sensors, temperature sensors, seal sensors, gas concentration sensors, water sensors, and optical sensors.

In act S2, the system data may be provided, by the data acquisition unit, to a compression force controller. As described above, the compression force controller may be permanently attached to the stack or may be configured to be temporarily or removably attached to the stack at defined periodic intervals.

In act S3, the amount of force (and the timing of the application of force) applied by a force generating mechanism to the electrolyzer stack is controlled based on the system data.

Such an improved solution having a system that allows for actively managing stack compression in real time or periodically based on operating conditions of the stack as described herein may provide various operating advantages over conventional operating cells/stacks. For example, a dynamic/active system allows smart decisions to be made about when to choose to apply force, the amount of force to apply, and the displacement applied. Determining how much force to apply based on the operating conditions of the stack, adjusting for load balancing, and being able to smoothly control this process allows the selection of the amount of compression force based on the operating condition of the stack, which improves seal and membrane life.

Additionally, the improved solution having a system with an actively managed compression force control based on real time stack conditions improves the serviceability of the system. In the tie-rod or bolt system described above, in order to service the system someone would need to unscrew a number of bolts and remove the hardware of the bolt system, such as the numerous conical spring washers, in order to access the stack. With the disclosed actively controlled force generating mechanism (i.e., dynamic compression system), the force generating mechanism, such as a compressor, can be backed off, which allows for the support structure (e.g., housing or frame) to expand allowing easy access to remove the stack, or individual cells from the stack.

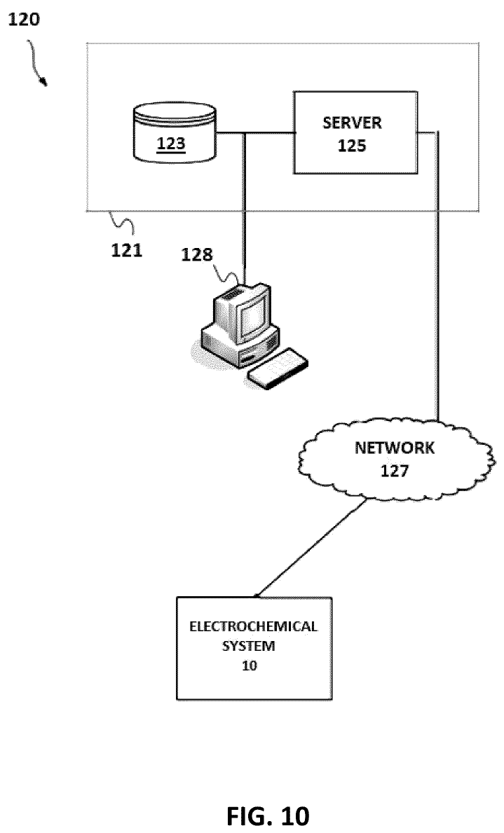

FIG. 10 illustrates an exemplary system 120 for controlling operation of an electrochemical cell or stack (e.g., including controlling the active compression of the electrochemical stack). The system 120 includes an electrochemical system 10, a monitoring system 121, a workstation 128, and a network 127. Additional, different, or fewer components may be provided. In some examples, the electrochemical system includes one or more of an electrochemical stack, a support structure for the stack, a compression system, a compression force controller, or a data acquisition unit, as described above in FIGS. 4-8.

The monitoring system 121 includes a server 125 and a database 123. The monitoring system 121 may include computer systems and networks of a system operator (e.g., the operator of the electrochemical system 10). The server database 123 may be configured to store information regarding the operating conditions or setpoints for optimizing the performance of the electrochemical system 10.

The monitoring system 121, the workstation 128, and the electrochemical system 10 are coupled with the network 127. The phrase “coupled with” is defined to mean directly connected to or indirectly connected through one or more intermediate components. Such intermediate components may include hardware and/or software-based components.

The optional workstation 128 may be a general-purpose computer including programming specialized for providing input to the server 125. For example, the workstation 128 may provide settings for the server 125. The workstation 128 may include at least a memory, a processor, and a communication interface.

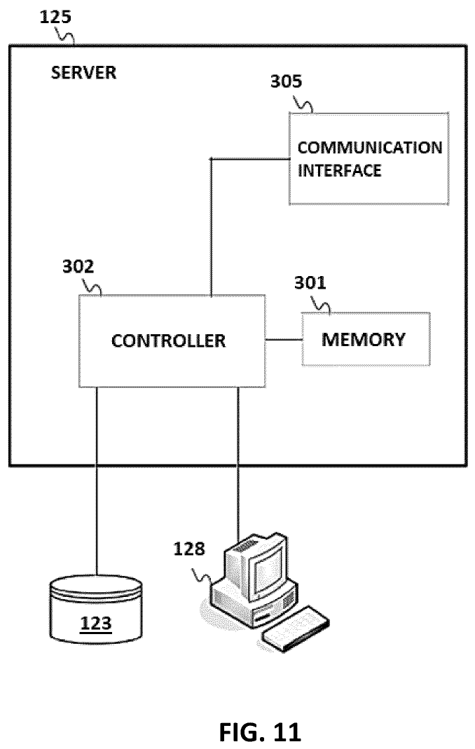

FIG. 11 illustrates an exemplary server 125 of the system of FIG. 10. The server 125 includes a memory 301, a controller or processor 302 (e.g., a compression force controller), and a communication interface 305. The server 125 may be coupled to a database 123 and a workstation 128. The workstation 128 may be used as an input device for the server 125. The communication interface 305 receives data indicative of use inputs made via the workstation 128 or a separate electronic device.

The controller or processor 302 (e.g., the compression force controller) may include a general processor, digital signal processor, an application specific integrated circuit (ASIC), field programmable gate array (FPGA), analog circuit, digital circuit, combinations thereof, or other now known or later developed processor. The controller or processor 302 may be a single device or combination of devices, such as associated with a network, distributed processing, or cloud computing.

The controller or processor 302 may also be configured to cause the electrochemical cell or stack to: (1) control when and how much force is applied by the force generating mechanism to the electrochemical stack; and/or (2) control when and how much force is applied by the force generating mechanism based on the stack data measured, monitored, and/or received by the data acquisition unit.

The memory 301 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the device 122, such as a secure digital (SD) memory card.

The communication interface 305 may include any operable connection. An operable connection may be one in which signals, physical communications, and/or logical communications may be sent and/or received. An operable connection may include a physical interface, an electrical interface, and/or a data interface. The communication interface 305 provides for wireless and/or wired communications in any now known or later developed format.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any digital computer. A processor may receive instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server may be remote from each other and typically interact through a communication network. The relationship of client and server arises by virtue of computer programs running on the respective computers and having a client-server relationship with each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A system comprising:
an electrolyzer stack comprising a plurality of electrolytic cells;
a force generating mechanism operable to adjust a force applied to control a compression of the electrolyzer stack, wherein the force generating mechanism comprises: (1) a plurality of hydraulic nuts, pneumatic nuts, or bolt tensioners; and (2) at least one pressure source or hydraulic reservoir in communication with the plurality of hydraulic nuts, pneumatic nuts, or bolt tensioners;
a compression force controller in communication with the force generating mechanism, the compression force controller configured to control an amount of the force applied by the force generating mechanism; and
a data acquisition unit in communication with the electrolyzer stack and the compression force controller,
wherein the data acquisition unit is operable to measure, monitor and/or receive system data in real time, and
wherein the compression force controller is configured to control how much force is applied by the force generating mechanism based on the system data measured, monitored, and/or received by the data acquisition unit.

2. (canceled)

3. The system of claim 1, wherein the compression force controller is configured to control the plurality of hydraulic nuts, pneumatic nuts, or bolt tensioners together such that a same force is applied to each hydraulic nut, pneumatic nut, or bolt tensioner of the plurality of hydraulic nuts, pneumatic nuts, or bolt tensioners.

4. The system of claim 1, wherein the compression force controller is configured to independently control each hydraulic nut, pneumatic nut, or bolt tensioner such that a same force or a different force is configured to be applied to each hydraulic nut, pneumatic nut, or bolt tensioner of the plurality of hydraulic nuts, pneumatic nuts, or bolt tensioners.

5. The system of claim 1, wherein the plurality of hydraulic nuts, pneumatic nuts, or bolt tensioners are grouped within a plurality of different zones, and
wherein the compression force controller is configured to control each zone of hydraulic nuts, pneumatic nuts, or bolt tensioners such that a same force or a different force is configured to be applied to each zone of hydraulic nuts, pneumatic nuts, or bolt tensioners.

6. A system comprising:
an electrolyzer stack comprising a plurality of electrolytic cells;
a force generating mechanism operable to adjust a force applied to control a compression of the electrolyzer stack;
a compression force controller in communication with the force generating mechanism, the compression force controller configured to control an amount of the force applied by the force generating mechanism;
a data acquisition unit in communication with the electrolyzer stack and the compression force controller, wherein the data acquisition unit is operable to measure, monitor and/or receive system data in real time; and
a support structure coupled to the electrolyzer stack, wherein the support structure comprises:
a first end plate; and
a second end plate, wherein the electrolyzer stack is positioned in between the first end plate and the second end plate; and
a plurality of tie rods or bolts, each tie rod or bolt configured to be positioned through a respective opening of the first end plate and a respective opening of the second end plate to assist in securing the electrolyzer stack between the first end plate and the second end plate,
wherein each tie rod or bolt of the plurality of tie rods or bolts is coupled to a component of the force generating mechanism,
wherein the compression force controller is configured to control how much force is applied by the force generating mechanism based on the system data measured, monitored, and/or received by the data acquisition unit.

7. The system of claim 6, wherein each tie rod of the plurality of tie rods is configured to be threaded and secured in a respective opening of the first end plate.

8. The system of claim 6, wherein the support structure is configured such that the force applied by the force generating mechanism is applied evenly to a surface of the electrolyzer stack.

9. The system of claim 6, wherein the support structure further comprises:
a spreader plate positioned between the first end plate and the electrolyzer stack; and
an array of springs positioned between the first end plate and the spreader plate.

10.-11. (canceled)

12. A system comprising:
an electrolyzer stack comprising a plurality of electrolytic cells;
a force generating mechanism operable to adjust a force applied to control a compression of the electrolyzer stack, wherein the force generating mechanism comprises: (1) a hydraulic press or at least one hydraulic piston; and (2) at least one pressure source or hydraulic reservoir in communication with the hydraulic press or the at least one hydraulic piston, and wherein the force generating mechanism is detachably connected to the electrolyzer stack;
a compression force controller in communication with the force generating mechanism, the compression force controller configured to control an amount of the force applied by the force generating mechanism;
a data acquisition unit in communication with the electrolyzer stack and the compression force controller, wherein the data acquisition unit is operable to measure, monitor and/or receive system data in real time; and
a support structure coupled to the electrolyzer stack, wherein the support structure comprises:
a first end plate; and
a second end plate, wherein the electrolyzer stack is positioned in between the first end plate and the second end plate;
a plurality of tie rods or bolts, each tie rod or bolt configured to be positioned through a respective opening of the first end plate and a respective opening of the second end plate to assist in securing the electrolyzer stack between the first end plate and the second end plate; and
a plurality of nuts associated with the plurality of tie rods or bolts, wherein each tie rod or bolt is threaded through respective nuts of the plurality of nuts on each end of a respective tie rod or bolt,
wherein the force generating mechanism is configured to be positioned adjacent to either the first end plate or the second end plate of the support structure, and
wherein, after application of a compression force by the force generating mechanism onto the first end plate or the second end plate, one or more nuts of the plurality of nuts are configured to be adjusted to retain the compression force on the electrolyzer stack.

13. A system comprising:
an electrolyzer stack comprising a plurality of electrolytic cells; and
a support structure positioned adjacent to a surface of the electrolyzer stack,
wherein the support structure is configured to uniformly apply a force over the surface to control an operating compression within the electrolyzer stack, and
wherein the support structure comprises:
a first end plate;
a second end plate, wherein the electrolyzer stack is positioned between the first end plate and the second end plate,
a plurality of tie rods or bolts, each tie rod or bolt configured to be positioned through a respective opening of the first end plate and a respective opening of the second end plate to assist in securing the electrolyzer stack between the first end plate and the second end plate;
a spreader plate positioned between the first end plate and the electrolyzer stack; and
an array of springs positioned between the first end plate and the spreader plate.

14. (canceled)

15. The system of claim 13, wherein each tie rod of the plurality of tie rods is configured to be threaded and secured in a respective opening of the first end plate or a respective opening of the second end plate.

16. A method of actively managing electrolyzer stack compression, the method comprising:
receiving, by a data acquisition unit, stack data from an electrolyzer stack in real time;
providing, by the data acquisition unit, the stack data to a compression force controller; and
controlling, by the compression force controller, how much force is applied by a force generating mechanism to the electrolyzer stack based on the stack data,
wherein the force generating mechanism comprises: (1) a plurality of hydraulic nuts, pneumatic nuts, or bolt tensioners; and (2) at least one pressure source or hydraulic reservoir in communication with the plurality of hydraulic nuts, pneumatic nuts, or bolt tensioners.

17. The method of claim 16, wherein the stack data is indicative of operating condition of the electrolyzer stack and comprises pressure data, temperature data, seal data, cell and/or stack height data, gas concentration data, and/or water data.

18. (canceled)

19. The method of claim 16, wherein the compression force controller controls the plurality of hydraulic nuts, pneumatic nuts, or bolt tensioners together such that a same force is applied to each hydraulic nut, pneumatic nut, or bolt tensioner of the plurality of hydraulic nuts, pneumatic nuts, or bolt tensioners.

20. The method of claim 16, wherein the compression force controller independently controls each hydraulic nut, pneumatic nut, or bolt tensioner such that a same force or a different force is configured to be applied to each hydraulic nut, pneumatic nut, or bolt tensioner of the plurality of hydraulic nuts, pneumatic nuts, or bolt tensioners.

21. The method of claim 16, wherein the plurality of hydraulic nuts, pneumatic nuts, or bolt tensioners are grouped within a plurality of different zones, and
wherein the compression force controller controls each zone of hydraulic nuts, pneumatic nuts, or bolt tensioners such that a same force or a different force is configured to be applied to each zone of hydraulic nuts, pneumatic nuts, or bolt tensioners.

22. The method of claim 16, wherein the data acquisition unit comprises pressure sensors, temperature sensors, seal sensors, gas concentration sensors, water sensors, and/or optical sensors.

23.-24. (canceled)

25. A method of actively managing electrolyzer stack compression, the method comprising:
receiving, by a data acquisition unit, stack data from an electrolyzer stack in real time;
providing, by the data acquisition unit, the stack data to a compression force controller; and
controlling, by the compression force controller, how much force is applied by a force generating mechanism to the electrolyzer stack based on the stack data,
wherein the force generating mechanism comprises: (1) a hydraulic press or at least one hydraulic piston; and (2) at least one pressure source or hydraulic reservoir in communication with the hydraulic press or the at least one hydraulic piston,
wherein the force generating mechanism is detachably connected to the electrolyzer stack,
wherein a support structure is coupled to the electrolyzer stack,
wherein the support structure comprises:
a first end plate; and
a second end plate, wherein the electrolyzer stack is positioned in between the first end plate and the second end plate;
a plurality of tie rods or bolts, each tie rod or bolt configured to be positioned through a respective opening of the first end plate and a respective opening of the second end plate to assist in securing the electrolyzer stack between the first end plate and the second end plate; and
a plurality of nuts associated with the plurality of tie rods or bolts, wherein each tie rod or bolt is threaded through respective nuts of the plurality of nuts on each end of a respective tie rod or bolt, and
wherein the method further comprises adjusting one or more nuts of the plurality of nuts are configured to be adjusted to retain a compression force on the electrolyzer stack after application of the compression force by the force generating mechanism to the electrolyzer stack.
